(19) United States
(12) Patent Application Publication
(10) Pub. No.: US 2008/0219154 A1
(43) Pub. Date: Sep. 11, 2008

(54) METHOD OF SENDING DATA PACKETS FROM A SERVER TO CLIENTS VIA A DATA LINK THAT HAS A GIVEN ERROR RATE

(75) Inventors: Florent DURREY, Toulouse (FR); Frederic Trinquecoste, Toulouse (FR); Paulo Correa, Costa Brava, CA (US)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 12/041,813

(22) Filed: Mar. 4, 2008

(30) Foreign Application Priority Data
Mar. 9, 2007 (FR) 07 01740

(51) Int. Cl. H04L 12/56

(52) U.S. Cl. 370/225

(57) ABSTRACT

The present invention relates to a method of sending data packets from a server to clients via a first data link that has a given error rate. The clients are interconnected by a second data link that has a lower error rate than that of the first link. The server sends all the packets to all the clients over the first link, regardless of the client that is the recipient of each of the packets. A client that detects that it has not received a packet of which it is the recipient over the first link requests the other clients to send said packet to it over the second link. The Invention is particularly applicable for video-on-demand.

### RELATED APPLICATIONS

The present application is based on, and claims priority from, French Application Number 07 01740, filed Mar. 9, 2007, the disclosure of which is hereby incorporated by reference herein in its entirety.

### FIELD OF THE INVENTION

The present invention relates to a method of sending data packets from a server to clients via a data link that has a given error rate. The invention applies, for example, to the field of video-on-demand, where the client simultaneously displays the video data that it receives.

### BACKGROUND OF THE INVENTION

The present patent application follows on from a French application filed on Jan. 5, 2007 under the No. 07/00059, hereinafter referred to as “prior application”. The present invention sets out to further enhance the effectiveness of the invention disclosed in the prior application. The two inventions aim to resolve a similar technical problem by quite different approaches and means. Used in combination, the two inventions complement each other and are particularly effective.

New entertainment and communication services are now offered to commercial or business airplane passengers, these services being commonly combined under the heading of “In-Flight Entertainment” (hereinafter called IFE services). The services concerned can, for example, be high-speed Internet access or even a video-on-demand service for each passenger. Thus, each passenger can, for example, choose to individually watch any video content, such as a film. An appropriate interface enables each passenger to select what he wants to watch. The film starts almost instantaneously, there is even no need to wait for the film to download, which would take a fairly long time. Subsequently, he can temporarily suspend the viewing then resume it or rewind to watch a sequence again or even fast forward to skip sequences, still with the same instantaneity with which the display started up. For the passenger, everything happens as if he were in the home watching a television connected to a video disc player.

This type of service is now available on board many airplanes. The current systems use notably display modules in the backs of the seats, input modules in the seat armrests, player and transmission modules at the cabin head level, all these modules being interconnected by wired links. The IFE systems have consequently resulted in an explosion in the quantity of wiring for each seat, to the detriment of the configurability of the cabin.

Now, the configurability of the cabin is an important marketing asset for aircraft manufacturers, notably the possibility for the customers to choose the number and layout of the seats. In practice, apart from a few safety constraints, the airlines are relatively free as to the internal arrangement of the cabin when they order an airplane. This is so that they can adapt the cabin to the type of client on the route that they are planning to operate. The IFE wiring of the seats has therefore become an increasingly costly brake on the versatility of the aircraft. However, in the same way, a complete and efficient IFE system has also become a major marketing asset for the aircraft manufacturers. The increased competition in the air transport field and the resulting democratization of air travel have meant that the IFE services, which might have seemed ancillary when they first appeared, have become essential to winning market shares. It was therefore appropriate to reconcile the technical constraints of the IFE systems with an optimum configurability of the cabin.

Thus, aware of the growth in wireless information transfer technologies, some aircraft manufacturers have, in agreement with the airlines and the IFE system providers, purely and simply eliminated certain of the IFE cables going to the seats that most hamper the configurability of the cabin. Only cables linking the seats in small groups of two, three or four seats have been retained. It is up to the IFE system providers to adapt, notably by making the most of the remaining wiring, which is the object of the present invention, and by exploiting the wireless technologies to the maximum, which is the object of the invention disclosed in the prior application.

Developing a wireless communication protocol dedicated to video-on-demand in an IFE system would no doubt have resulted in a very efficient solution, but this would doubtless also have been very expensive. This is why the use of a communication standard was preferred. Unfortunately, none of the current standards addresses all the issues of video-on-demand in an IFE system. However, given in particular the maturity of the different technologies, the IEEE 802.11a, IEEE 802.11b, IEEE 802.11 g or IEEE 802.11 n standards, better known by the commercial designation of “WiFi links”, seem best suited. They have consequently been adopted. In practice, the WiFi links give results that are quite satisfactory in video applications for the mass market, but with no multiple-broadcast constraint or display simultaneity constraint. Hereinafter, they will also be combined under the generic designation of 802.11.

In practice, on board a long-haul airplane, several tens, or even several hundreds, of passengers can simultaneously watch different films, each passenger being able to pause, fast forward or rewind at will in the film that he is watching. Consequently, each film watched by a passenger constitutes a particular session, the corresponding video data stream having to be sent exclusively to the display screen of a single passenger. For example, an IFE system can simultaneously broadcast 300 sessions. Such a multiple-broadcast constraint exists in no current WiFi link consumer video application. Similarly, the current WiFi link video applications do not provide virtually instantaneous display, notably when the film starts. Waiting times of several seconds, sometimes masked by advertising or warning messages, are necessary before a play command is actually executed. Thus, the applications that use a WiFi link in the home normally use the IEEE802.11b and IEEE802.11 g standards which provide three channels in the 2.4 gigahertz region for a total bit rate that can range up to 90 megabits per second (Mbps) (approximately 30 Mbps per channel). A small number (a few units) of video streams can be sent simultaneously per channel. This is not sufficient in the context of video-on-demand in an IFE system, for which the IEEE 802.11a standard seems better suited. The latter provides 23 channels between 5 and 6 gigahertz for a total bit rate that can range up to 600 Mbps (still 30 Mbps per channel). However, even so, the IEEE 802.11a standard is not perfectly suited to the requirements of video-on-demand in an IFE system.

In practice, the IEEE 802.11a standard does not guarantee that a packet is received, or even guarantee that a packet is received at a reasonable cost. Because the 802.11 standards are based on an acknowledgement mechanism whereby a message named ACK, an abbreviation of “ACKnowledgement”, is sent to a transmitting WiFi device for each data packet received by a receiving WiFi device. The sending WiFi device resends the packet to the receiving WiFi device until it receives the corresponding ACK message. After having been resent a certain number of times, the packet is no longer resent and it is definitively lost for the receiving WiFi device. With this mechanism, besides the fact that the bandwidth is used up in sending the ACK messages, it should be noted that, to recover a first lost packet, possibly numerous other packets may be lost subsequently! Thus, if the error rate is high, that is, if the number of packets lost in relation to the number of packets sent is high, delay can easily build up and errors can appear on the screen. Such is the issue the 802.11 standards address by reducing the bit rate, which is unacceptable in the context of multiple video-on-demand. A key characteristic of the standard WiFi links is that they provide a permanent trade-off between error rate and bit rate. If the error rate increases, the bit rate decreases, and vice-versa. It should moreover be noted that data packets can be definitively lost and that ultimately displayed data can contain errors, which are manifested in most cases by black or non-refreshed pixels. Some display terminals try to mitigate the visual discomfort that these residual errors can cause, by image smoothing methods for example. Ensuring a constant bit rate on a WiFi link is one of the technical problems to which the invention disclosed in the prior application sets out to provide a solution.

In the relatively cramped cabin of an airplane, even one of the size of a long-haul airplane, the errors are not due to the distance between the sending WiFi device and the receiving WiFi device. The problem lies in a classic phenomenon known as “micro-fading”: at very high frequency, the reception level can vary in time and in space. In the present case, the “micro-fading” is explained on the one hand by a phenomenon of resonance of the water molecules at the frequency used, water being very prevalent in the body of each of the many passengers in constant motion, and on the other hand by a phenomenon of reflection of the waves on metal objects, metal being omnipresent in the cabin of an airplane.

The WiFi technology, initially designed to bring the Internet to the home, exchange emails and download files with no real-time constraint, was not designed to be robust to the “micro-fading” phenomenon and provide a constant bit rate. Certain more recent 802.11 standards to intend to provide a quality of service in terms of latency, error rate and bit rate. However, they will rely on a mechanism involving buffering at least ten or so seconds of data, which is incompatible with the quasi-instantaneity of display demanded by video-on-demand in an IFE system, in particular on startup. The requirements of video-on-demand in an IFE system do not therefore definitively match up to the WiFi technology development constraints. This is one of the reasons why there is currently no multiple video-on-demand in a wireless IFE system. These days, a cabin head player module is still linked to the screens by an end-to-end wired link passing through the seats. The invention disclosed in the prior application sets out to resolve the problem of non-constant bit rate on a WiFi link, in order to enable video-on-demand to be set up in a wireless IFE system.

The invention disclosed in the prior application is particularly effective when the nominal error rate on the link is less than 10⁻². Such is very often the case in practice, notably thanks to the existing acknowledgement mechanisms implemented in the low level OSI layers. Thus, the invention disclosed in the prior application ensures that, if the nominal error rate is equal to or less than 10⁻³ at the start, then it falls below 10⁻⁶ subsequently. When used in the context of a multiple-client application such as video-on-demand in an IFE system, it also makes it possible to prevent the degradations in the reception level that a particular client may experience from having any impact on the other clients. It prevents the measures for recovering data lost by a client from slowing down the links of the other clients.

Unfortunately, the invention disclosed in the prior application is less effective when the nominal error rate is equal to or greater than 10⁻². In this extremely unfavorable case, the invention disclosed in the prior application no longer manages to effectively correct the errors, because they are too numerous. Tests have shown that the error rate is then maintained at a substantially identical value. Consequently, the error rate remains high for a few particularly unfavorably treated clients. However, one advantage of the invention disclosed in the prior application is that these unfavorably treated clients do not disrupt the other clients: a poor reception level remains localized and is not propagated.

The present invention sets out to make a first correction upstream of the method that is the subject of the invention disclosed in the prior application. In practice, the invention disclosed by the prior application is fully effective only if it can be ensured that the error rate is no greater than 10⁻³ at any moment and for any receiver. The present invention limits the number of clients for which the error rate is equal to or greater than 10⁻², this case being relatively frequent over all the passengers of an airplane. The invention disclosed in the prior application therefore becomes effective for a larger number of clients. It should be noted that the present invention is capable of correcting, at any moment and for any client, a high error rate, equal to or greater than 10⁻², but that it is capable of reducing this error rate only to a mean level of the order of 10⁻³ or 10⁻⁴, a level that is unacceptable in the context of video-on-demand. It is the invention disclosed in the prior application that makes it possible in a second stage to further reduce the error rate to a very low level of the order of 10⁻⁶, a level that is acceptable in the context of video-on-demand.

### SUMMARY OF THE INVENTION

A main aim of the present invention is therefore to provide an error rate that, although average, is substantially uniform over all the clients. It, in any case, ensures that, apart from extreme cases, no client has an error rate that is so catastrophic that it would not be possible to correct it by retransmission mechanisms between the server and the client. To this end, the subject of the invention is a method of sending data packets from a server to clients via a first data link that has a given error rate. The clients are interconnected via a second data link that has an error rate that is lower than that of the first link. The server sends all the packets to all the clients over the first link, regardless of the client that is the recipient of each of the packets. A client that detects that it has not received a packet of which it is the recipient over the first link requests the other clients to send said packet to it over the second link.

For example, the first data link can be a wireless link like a WiFi link and the second data link can be a wired link like an Ethernet link.

Advantageously, the server can send a given packet only once over the first link, by addressing said packet to all the clients.

Advantageously once again, at least three clients can be interconnected by the second link, a client requesting the other clients a given packet only once over the second link, by addressing said request to all the other clients.

The server can number the packets that it sends to the clients, a client using the numbering of the packets to detect that it has not received a packet.

In one embodiment, the clients can be interconnected via their receivers. The packets can contain, for example, audio and/or video data that can be used by player modules included in the clients. These audio and/or video data can, for example, be broadcast to passengers of an aircraft.

Also, main advantages of the present invention include limiting the retransmission requests over the wireless link and therefore saving its bandwidth, which is not without interest on a link that is already fairly unreliable without retransmissions. It also provides a very profitable client redundancy mechanism. In practice, in cases where the operation of one of the clients is interrupted then restarted, the client can restore all its data without requesting the server anything over the wireless link. It only has to make the requests over the wired link to the other clients, the operation of which will very probably be maintained during the interruption.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, an illustration by an architectural diagram of an exemplary implementation of the present invention in a video-on-demand system on board an aircraft;

FIG. 2, an illustration by an architectural diagram of an exemplary implementation of the present invention in a receiver;

FIG. 3, an illustration by an architectural diagram of an exemplary implementation of the present invention in combination with the invention disclosed in the prior application.

### DETAILED DESCRIPTION OF THE DRAWINGS

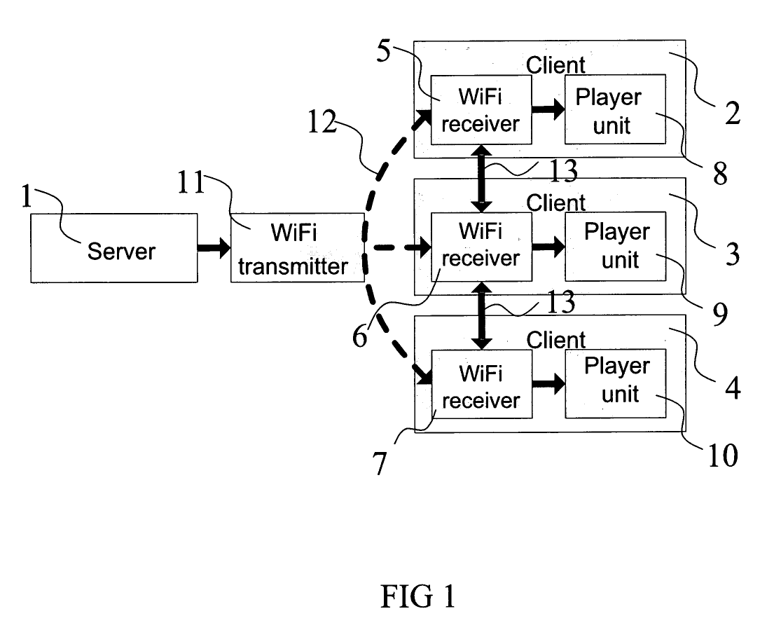

FIG. 1 uses an architectural diagram to illustrate an exemplary implementation according to the present invention of a video-on-demand system on board an aircraft. In the embodiment of FIG. 1, a server 1 sends, for example, audio and video data streams to three clients 2, 3 and 4, via a transmitting WiFi device 11 and a WiFi link 12. It should be noted that any other type of link can be envisaged, wired or wireless. In the present IFE field, the clients 2, 3 and 4 are, for example, video display modules including receiving WiFi devices 5, 6 and 7, and player units 8, 9 and 10 respectively. The clients could also be modules giving the current geographic position of the aircraft. Advantageously, the receivers 5, 6 and 7 are interconnected via an Ethernet link 13 compliant with the IEEE802.3 standard. It should be noted that any other type of link can be envisaged. It is, however, desirable for the link between the clients 2, 3 and 4 to be more reliable than the link with the server 1, in order to fully exploit the present invention. In this way, the clients 2, 3 and 4 can listen to the data streams intended for the other nearby clients.

Advantageously, the server 1 sends all the data packets to one and the same address for all of the group formed by the three clients 2, 3 and 4. This sending method is commonly referred to as sending “in multicast mode”. By extension, the terms “multicast stream” and “multicast packets” shall be used hereinafter to refer to these streams and these packets sent “in multicast mode” or even “with multicast address”. In real terms, the various streams are sent to different ports of the receivers 5, 6 and 7 sharing the same address. A client can listen to all these ports and claim up to four ports for its own use. The fact that the streams are sent “in multicast mode” is very important. This is because, if the data packets were sent to one address for each of the clients 2, 3 and 4, this sending method being referred to as sending “in unicast mode”, each client could see only its own streams and no other. This is most particularly the case when using the encryption procedures of the 802.11 standard. It would then not be possible to implement the present invention. Furthermore, a stream sent “in unicast mode” behaves unpredictably. When a packet is sent “in unicast mode”, the bandwidth that it uses depends on the bit rate, on the number of times that it is lost and on its size. Also, it requires an acknowledgement. Compared to this, the use of the bandwidth by a “multicast packet” depends on nothing other than its size. The transmission rate is fixed, the number of transmissions is always one and it does not require any acknowledgement. Although the probability of a receiver losing a packet is greater “in multicast mode” than “in unicast mode”, because there are no more low-layer retransmissions, sending “in multicast mode” even so presents the advantage that the total usage of the bandwidth can be accurately known, which makes it easier to dimension the system. Consequently, to implement the present invention, it is essential to use “multicast streams” to send the audio and video data streams.

The normal path of a packet in an audio and video data stream is that described below. First, the packet is sent by the server 1 to a “multicast address”, for example 239.255.1.1, via the WiFi transmitter 11. The data packet is an RTP (Real-Time Transport Protocol) packet, so it contains an RTP header with a sequence number. One example can be to use the RTP header described by the RFC 3551 standard. The WiFi transmitter 11 retransmits the packet to the three WiFi receivers 5, 6 and 7 of the three clients 2, 3 and 4 respectively. Only one of the three clients 2, 3 or 4 is the recipient of the packet, that is, only one of the clients will actually use the packet to broadcast its audio or video content. Assume that it is the client 3. The receiver 6 of the client 3 stores the packet in a buffer memory space and sends it to the player unit 9. An exemplary buffer memory structure for the receiver 6 will be given below. The receivers 5 and 7 simply store the packet in a buffer memory space; they do not send it to their respective player units 8 and 10. In the nominal case where the receiver 6 does not miss the packet, that is, if, in the area of the receiver 6, the effects of the micro-fading phenomenon were low at the moment immediately following the sending by the WiFi transmitter 11, the process stops there.

Similarly, if one or both of the receivers 5 and 7 has not or have not received the packet, that is, if the effects of the micro-fading phenomenon were great in the areas of the receivers 5 and 7 at the moment immediately following the sending by the WiFi transmitter 11, then nothing more happens and the process once again stops there. In practice, the clients 2 and 4 do not effectively use the packet. At the very most, they can keep a trace of the fact that the packet has been lost, made possible on the basis of the sequence numbers in the RTP headers of the received packets. For example, if a packet with the sequence number k is received, where k is a natural integer number, then the following packet should be numbered k+1. If the following packet is numbered k+2, then the receiver can easily deduce that the packet k+1 has been sent but not received. This explanation is highly schematic; a more realistic exemplary implementation will be detailed hereinbelow.

On the other hand, if the receiver 6 of the client 3 has not received the packet, that is, if the effects of the micro-fading phenomenon were great in the area of the receiver 6 at the moment immediately following the sending by the WiFi transmitter 11, then the packet must be recovered because the client 3 uses this packet effectively to broadcast its audio or video content via the player unit 9. The receiver 6 therefore sends a retransmission request to the receivers 5 and 7 via the Ethernet link 13. In practice, it is highly probable that at least one of them has received the packet. It should be noted that the fact that the retransmission request is not sent to the server 1 over the WiFi link 12, which would have been compliant with the invention disclosed in the prior application, allows a bandwidth saving on this link that is already failing in this case. Advantageously, a single request is addressed to the receiver 5 and to the receiver 7 using a single packet sent “in broadcast mode” over the Ethernet link 13. The sending method commonly referred to as sending “in broadcast mode” enables a packet to be sent to all the clients of a network. Thus, if there had been clients other than the clients 2 and 4 on the Ethernet network 13, they would also have received the retransmission request. The retransmission request contains the sequence number of the lost packet and the port of the stream concerned.

When the receivers 5 and 7 receive the request, they each consult the packets that they have stored in their buffer memories and look for the packet whose retransmission is requested. If one of them has received it, then it resends the packet concerned to the receiver 6. Otherwise, it does not respond to the request. Consequently, the receiver 6 may receive no response to its retransmission request or receive a response to its request or even receive two responses to its request. In the case where it receives at least one response to its request, it stores this response in its buffer memory and sends it to its player unit 9 to broadcast its content. It should be noted that this is not a problem if a number of packets containing the same RTP sequence number circulate simultaneously on the Ethernet link 13. In practice, the RTP protocol can detect and eliminate identical packets (duplicates). It is also able to re-order packets that have arrived in disorder, as is inevitably the case here. Moreover, the receiver 6 counts the recovered packets, which provides a way of measuring the residual error rate. It counts a retransmission response only once, by accessing its buffer memory to ascertain if a received response does not correspond to a packet already previously recovered. The receivers 5 and 7 do the same for the packets that they miss and whose retransmission they request. The residual error rate of each of the receivers 5, 6 and 7 provides a way of assessing the effectiveness of the present invention.

If both the receiver 5 and the receiver 7 have not received the packet requested by the receiver 6, then there is no retransmission over the Ethernet link 13. Consequently, there remains a non-zero residual error rate even after implementing the present invention. Fortunately, this residual error rate is better than the error rate before implementing the invention. Tests carried out by the applicant show that the worst error rate after implementing the present invention is better than the best error rate before. And this remains true even if one of the receivers 5, 6 or 7 has a very bad nominal error rate, for example of the order of 10⁻². It should be noted that this is not necessarily the case with the invention disclosed by the prior application, which proves effective only for nominal error rates of less than 10⁻². Consequently, it can be reasonably hoped that the present invention reduces the error rate to that of the best receiver among the receivers 5, 6 and 7. It significantly reduces the error rate of at least one or a few receivers in a given area that has very poor reception conditions, and this without using additional bandwidth at the expense of the other receivers.

It is important to understand that the known systems with several antennas are not comparable to the present invention. Among these systems may be mentioned, for example, the Yagi antenna, which is formed by a plurality of antennas aligned in a rake configuration, or the MIMO (Multiple-Input Multiple-Output) technology, which uses a plurality of antennas and reception loops in one and the same receiver. On the one hand, in these systems, it is always just one client connected to several antennas. In no case is there a community of interconnected clients each serving as an antenna for the community. On the other hand, in these systems, the antennas are practically co-located or separated by an extremely limited distance: a few centimeters at the frequencies involved. In no case are the antennas and receivers really remote and connected by a data link. Finally, these multiple-antenna systems always address a technical problem other than that of micro-fading. Thus, the plurality of antennas forming a Yagi antenna provides a way of aggregating the power (and therefore in a purely analog way) of the received signals to improve the reception of a signal. The plurality of antennas in the MIMO technology essentially provides a way of multiplying the bit rate. In no known case is the variation or the diversity in space of the reception level overcome by an exchange of missing information between several independent and remote receivers.

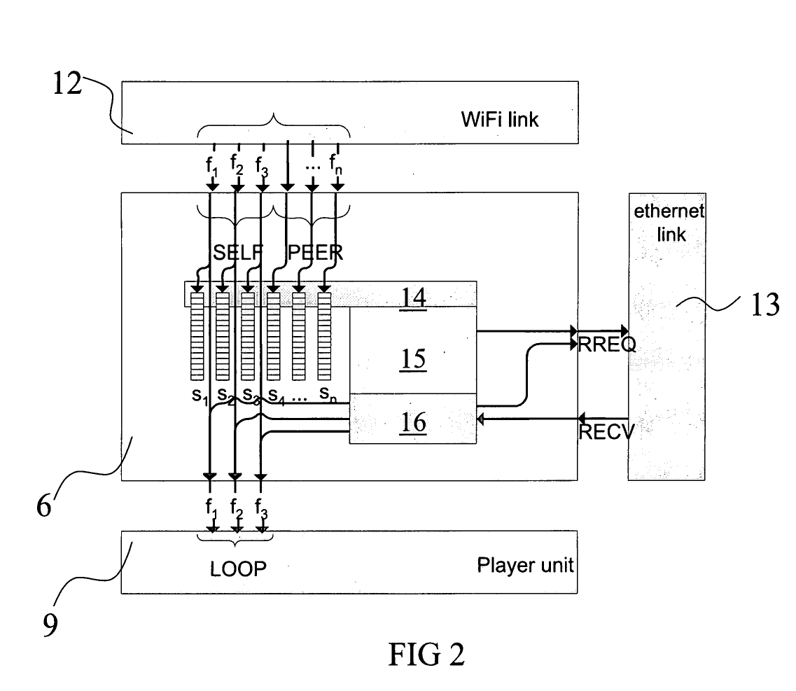

FIG. 2 is an architectural diagram illustrating an exemplary implementation of the present invention in the receiver 6 of the example of FIG. 1. On the WiFi link 12, the receiver 6 receives n audio and video data streams fᵢ, iε{1, . . . , n}. For example, only the streams f1, f2 and f3 are actually used by the client 3 of which the receiver 6 is part. The receiver 6 receives the streams f1, f2 and f3 “in multicast mode” via a dedicated communication point called SELF. A communication point is a conventional data structure, very well known by its name “socket”, which makes it possible to define the communication protocol between a transmitter and a receiver. The receiver 6 stores the streams f1, f2 and f3 in buffer memory and sends them to the player unit 9 “in unicast mode” via a LOOP “socket” to broadcast their audio or video content. The other streams from f₄ to fₙ are received via a PEER “socket” and simply placed in buffer memory; they are not sent to the player unit 9. For example, the buffer memory of the receiver 6 includes a storage structure for each stream, the stream fᵢ being stored in a structure sᵢ for iε{1, . . . , n}. Advantageously, each structure sᵢ can contain 16 data packets indexed from 0 to 15. In this exemplary embodiment, a packet of RTP sequence number equal to k is stored in the position of index N=k mod 16. Assuming that the packets are received in ascending order of the RTP sequence numbers one by one, N must therefore normally vary cyclically from 0 to 15 in increments of 1, then return to the index 0, and so on. Each time a packet is stored in a structure sᵢ where iε{1,2,3}, a checking module 14 can compare the new storage index with the preceding storage index, that it has memorized. If the new index does not correspond to the index that can be predicted from the preceding index based on the cyclical variation of the storage indices, then this means that at least one packet has been lost. In this case, a spatial decorrelation module 15 sends “in broadcast mode” a packet containing a request to retransmit the lost packet via an RREQ “socket” over the Ethernet link 13, to the receivers 5 and 7 not represented in FIG. 2. Very probably, a retransmission of the lost packet will be received subsequently “in unicast mode” over the link 13 by a retransmission processing module 16, via an RECV “socket”. The retransmitted packet will be sent to the player unit 9 to broadcast its audio or video content.

It should be noted that, possibly, the module 16 can itself receive a request to retransmit a packet coming from the receiver 5 or from the receiver 7 via the RECV “socket”. If it is present in one of the structures sᵢ, iε{4, . . . , n}, the requested packet is then retransmitted via the RREQ “socket”.

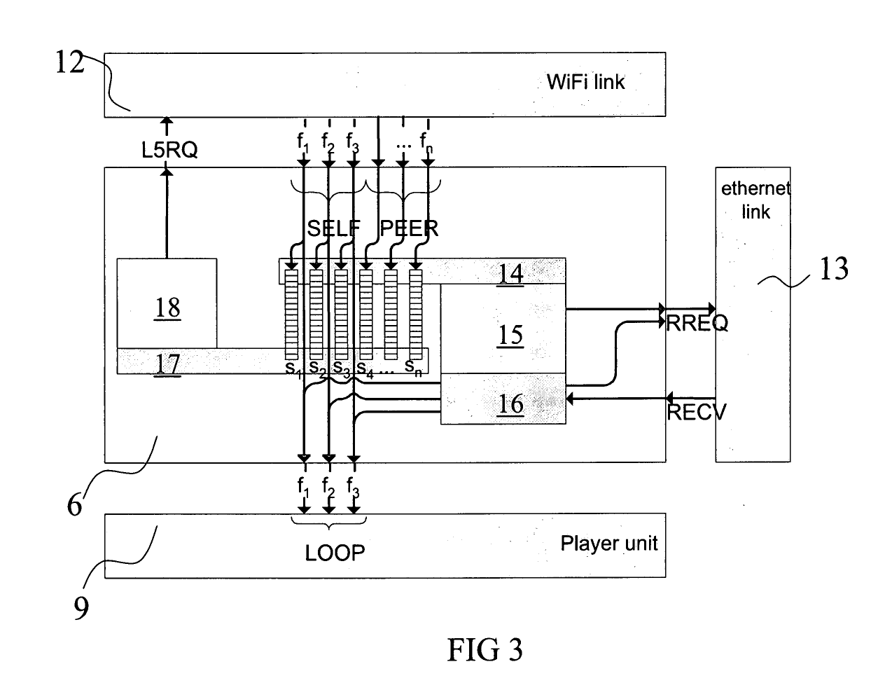

FIG. 3 is an architectural diagram illustrating an exemplary implementation of the present invention similar to that of FIG. 2, but this time in conjunction with the invention disclosed in the prior application. The receiver 6 is connected to the same WiFi link 12 and Ethernet link 13 and to the same player unit 9. The same streams fᵢ for iε{1, . . . , n} are received and stored in the same structures sᵢ for iε{1, . . . , n}. The same modules 14, 15 and 16 implement the present invention, making it possible to send and receive retransmission requests over the Ethernet link 13 to the receivers 5 and 7 not represented in FIG. 3.

Modules 17 and 18 implement the invention disclosed in the prior application. The checking module 17 searches in the structures sᵢ for iε{1,2,3}, on the basis of the RTP sequence numbers, to see if packets have been lost and have not been able to be recovered using the present invention. If necessary, the time decorrelation module 18 sends back to the server 1, not represented in FIG. 3, a request to retransmit said packet over the WiFi link 12 via an L5RQ “socket”, in accordance with the invention disclosed in the prior application. It should be noted that the modules 14, 15 and 16 implementing the present invention have priority over the modules 17 and 18 implementing the invention disclosed in the prior application. The modules 14, 15 and 16 work before the modules 17 and 18, because it is important to request the server 1 retransmissions via the WiFi link 12 only if neither of the two receivers 5 or 7 has received the packet concerned. Thus, the present invention provides a way of not using up the bandwidth on the WiFi link 12.

By its offset retransmission mechanism, the invention disclosed in the prior application sets out to overcome the micro-fading phenomenon from the temporal angle. The present invention for its past sets out to overcome it from the spatial angle. In practice, at a given instant, a drop in the reception level occurs at a given point of the airplane, not everywhere in the airplane: the scale of variation of the micro-fading at the frequencies concerned in an airplane is only a few centimeters. At this instant, at least one of the clients is likely not to be disturbed by the micro-fading. It can therefore serve as receiver for the other clients.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method of sending data packets from a server to clients via a first data link that has a given error rate, each packet being addressed to a client, the clients all being interconnected via a second data link (13) that has an error rate that is lower than that of the first link, comprising the steps of:
sending, by the server, sends all the packets to all the clients over the first link, regardless of the client that is the recipient of each of the packets;
detecting by a client that detects the client has not received a packet of which it is the recipient over the first link and requesting the other clients to send the packet to the client requesting the packet over the second link.

2. The method as claimed in claim 1, wherein the first data link is a wireless link and the second data link is a wired link.

3. The method as claimed in claim 1, wherein the first data link is a link compliant with the IEEE802.11 standard and the second data link is a link compliant with the IEEE802.3 standard.

4. The method as claimed in claim 1, wherein the server sends a given packet only once over the first link, by addressing said packet simultaneously to all the clients.

5. The method as claimed in claim 1, wherein at least three clients are interconnected by the second link.

6. The method as claimed in claim 1, wherein a client requests a given packet only once over the second link, by addressing said request to all the other clients.

7. The method as claimed in claim 1, wherein the server numbers the packets that it sends to the clients, a client using the numbering of the packets to detect that it has not received a packet.

8. The method as claimed in claim 1, wherein the clients are interconnected via their receivers.

9. The method as claimed in claim 1, wherein the packets contain audio and/or video data that can be used by player modules included in the clients.

10. The method as claimed in claim 9, wherein the audio and/or video data are broadcast to passengers of an aircraft.
